(19) United States
(12) Patent Application Publication
(10) Pub. No.: US 2006/0102270 A1
(43) Pub. Date: May 18, 2006

(54) Pneumatic tire

(75) Inventor: Masumi Suzuki, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/232,883

(22) Filed: Sep. 23, 2005

(30) Foreign Application Priority Data
Nov. 12, 2004 (JP) 2004-329509

(51) Int. Cl. B60C 15/04; B29D 30/50; B60C 15/06

(52) U.S. Cl. 152/540; 156/136; 152/542

(57) ABSTRACT

A pneumatic tire comprises a pair of bead portions, a carcass comprising a carcass ply extending between the bead portions, a pair of bead cores each disposed in each bead portion, the bead core comprising an annular core formed from one monofilament cord and a sheath having at least one sheath wire extending helically around the annular core, and a wrapping member wrapping the bead core and made of fabric-like body having an organic fiber cord.

### BACKGROUND OF THE INVENTION

1. Field of the Invention

The present invention relates to a pneumatic tire with a so-called cable bead as a bead core disposed in a bead portion.

2. Description of the Related Art

A bead core is disposed in a bead portion of a pneumatic tire. An end of a carcass ply is usually turned up around the bead core. As the bead core, so-called cable having a circular cross section comprising an annular core and at least one sheath layer surrounding the core are known. The sheath is formed by spirally winding at least one, preferable, a plurality of sheath wires around the core.

When the cable bead is twisted, the sheath wires are wound around the core tightly or loosely. Therefore, the cable bead has a merit that the cable bead is flexibly deformed with respect to the twisting. The bead core receives various forces from a carcass ply during running of a tire, but in the case of a tire using the cable bead, such forces are absorbed by the cable bead. Therefore, when the tire is loaded for example, the carcass ply is rotated around the core of the cable bead, the distortion of the carcass cord can be moderated, and the durability of the tire is enhanced. When a steering wheel of a vehicle is operated, the linearity of response thereof is enhanced. This is of help to enhance the steering stability.

According to the conventional tire, however, when the tire is vulcanized and formed, a portion of rubber permeates into the cable bead, and there is a tendency that the flexibility of the cable bead is deteriorated. Hence, the present inventors found that the above-described merit of the cable bead is not sufficiently exhibited in the conventional pneumatic tire.

### SUMMARY OF THE INVENTION

The present invention has been accomplished in view of the above problem, and it is an object of the invention to provide a pneumatic tire capable of sufficiently exhibiting the merit of the cable bead.

In accordance with the present invention, a pneumatic tire comprises:

a pair of bead portions;

a carcass comprising a carcass ply extending between the bead portions;

a pair of bead cores each disposed in each bead portion, said bead core comprising an annular core formed from one monofilament cord and a sheath having at least one sheath wire extending helically around the core; and

a wrapping member wrapping the bead core and made of fabric-like body having an organic fiber cord.

### BRIEF DESCRIPTION OF THE DRAWINGS

FIG. 1 is a sectional view showing an embodiment of a pneumatic tire of the present invention;

FIG. 2 is an enlarged perspective view of a bead core of the tire;

FIGS. 3(A) and (B) are plan views used for explaining a wrapping member;

FIGS. 4(A) and (B) are perspective views used for explaining a forming method of the wrapping member; and

FIG. 5 is a side view used for explaining the forming method of the wrapping member.

### DESCRIPTION OF THE PREFERRED EMBODIMENTS

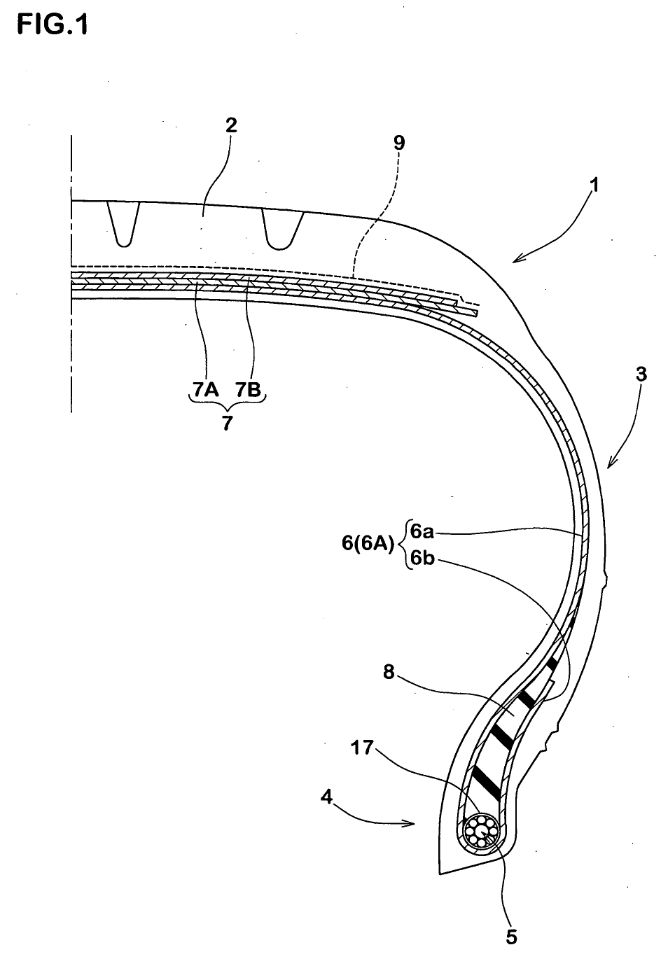

In FIG. 1, a pneumatic tire 1 for passenger car in accordance with present invention comprises: a tread portion 2; a pair of side wall portions 3; a pair of bead portions 4 with a bead core 5 therein; a carcass 6 comprising at least one carcass pry 6 of cords which extend between the bead portions 4 through the tread portion 2 and sidewall portions 3; and a belt 7 disposed radially outside the carcass in the tread portion 2.

The carcass 6 is composed of at least one ply, in this example only one ply 6A of cords arranged radially at an angle of 70 to 90 degrees with respect to the tire equator C.

The carcass ply 6A of cords is turned up around the bead cores 5 from the axially inside to the axially outside of the tire so as to form a pair of turnup portions 6b and a main portion 6a therebetween.

For the carcass cords, organic fiber cords, e.g. nylon, polyester, rayon, aramid and the like and steel cords may be used. From a viewpoint of a tire weight saving, the organic fiber cord is preferably used for the carcass code.

Each bead portion 4 is provided between the carcass ply main portion 6a and turnup portion 6b with a rubber bead apex 8 extending and tapering radially outwardly from the bead core 5.

The belt 7 comprises at least two cross plies of rubberized parallel belt cords which are laid at an angle of from 10 to 35 degrees with respect to the tire equator C. In this example, the belt 7 is composed of a radially outer ply 7B and a radially inner ply 7A. For the belt cords, steel cords, and high modulus organic fiber cords such as aramid, rayon and like can be used.

In order to further improve the high-speed durability of the belt 7, a band 9 which covers at least edge portions of the belt is disposed radially outside the belt 7. Here, the band 9 is a cord layer made of at least one cord spirally wound, or parallel cords having at angle of from 0 to 5 degrees with respect to the circumferential direction of the tire. In this embodiment, the band 9 comprises a single band ply having an eaual width substantially with the belt 7. For the band cords, organic fiber cords, e.g. nylon, rayon, aramid and the like may be used.

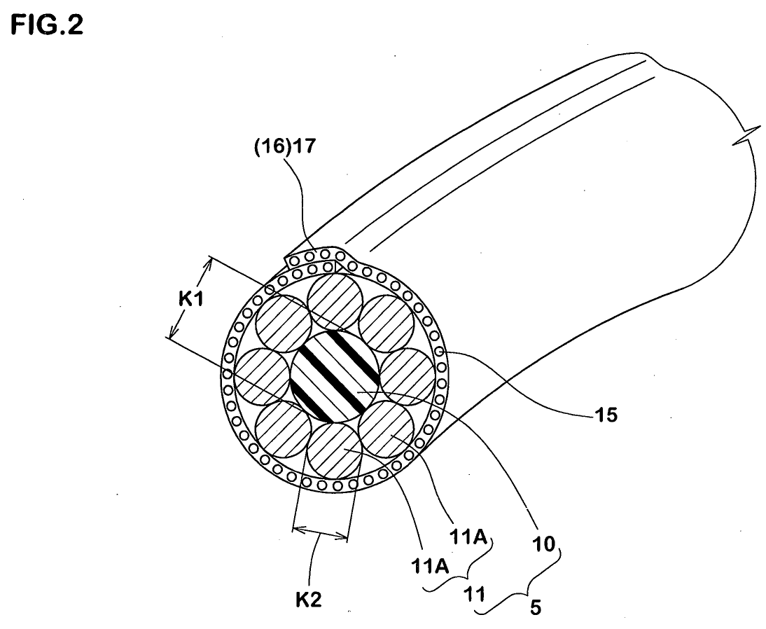

A cable bead having a circular cross section is used as the bead core 5. As shown in FIG. 2 in an enlarged scale, the bead core 5 comprises an annular core 10 formed from one monofilament, and one or more sheaths 11 surrounding the core 10. The sheath 11 comprises at least one, preferably a plurality of sheath wires 11A extending helically around the core 10. In this embodiment, the sheath 11 comprises one layer.

The annular core 10 mainly functions as a core around which the sheath wires 11A is helically wound, and as a core for holding the wound shape of the sheath wires 11A when the sheath wires 11A are vulcanized and molded. The strength of the bead core 5 is maintained mainly by the sheath wires 11A. The core 10 does not require so much strength. Therefore, metal material such as iron having high strength can of course be used for the core 10, but resin material having tensile elastic modulus of 1000 kg/mm² or less such as nylon, polyvinyl alcohol, polyethylene terephthalate and the like can be used for the core 10. As the metal material, a steel wire having carbon content of 0.1 to 0.9 wt % is preferable.

If a diameter K1 of the core 10 is extremely small, the second moment of the area of the sheath 11 becomes small and as a result, there is a tendency that the flexural rigidity of the bead core 5 becomes extremely small. If the diameter K1 of the core 10 becomes extremely large on the contrary, the bead core 5 becomes large unnecessarily, and this increases the weight of the tire. From such a viewpoint, the diameter K1 of the core 10 is preferably in a range of from 1.5 to 8.0 mm.

Metal material is preferable as the sheath wires 11A which becomes the strength member. More concretely, a piano wire defined in JIS G3502 and a steel wire such as hard-drawn wire defined in JIS G3506 are preferably used. In this embodiment, a hard-drawn wire having a diameter K2 of from 0.8 to 2.6 mm (K2<K1) and having carbon content of 0.65 to 0.88 wt % is preferably employed as the sheath wires 11A. To enhance the adhesion with respect to rubber, it is preferable that the surface of the core 10 made of metal material and a surface of the sheath wires 11A are plated with brass, zinc or the like.

A periphery of the bead core 5 is wrapped by a wrapping member 17. The wrapping member 17 is made of a sheet-like body 16 in which an organic fiber cord 15 is used. Examples of the organic fiber cord 15 of the sheet-like body 16 are nylon, polyester and vinylon.

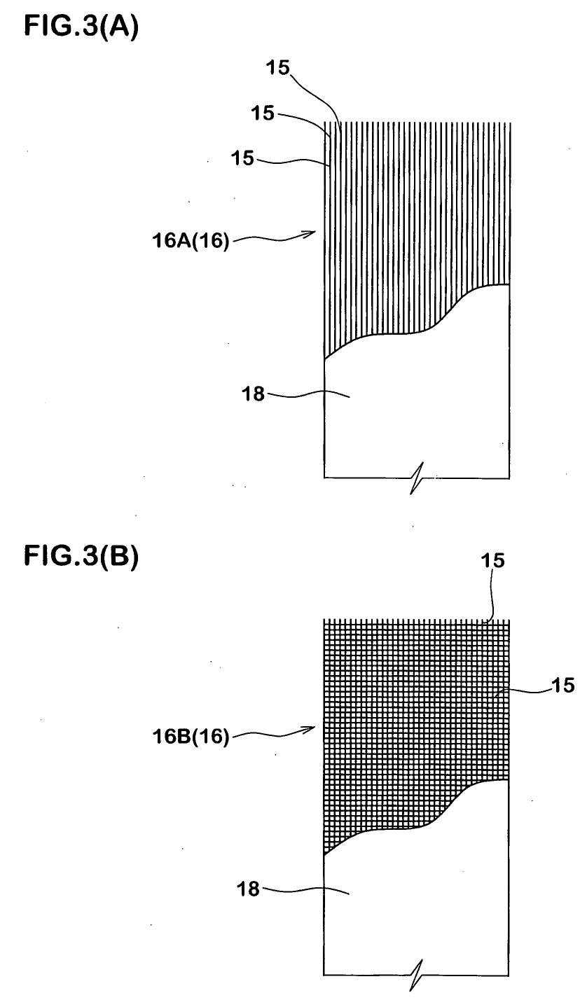

As the sheet-like body 16, a cord arranging body 16A in which the organic fiber cords 15 are arranged in parallel to each other as shown in FIG. 3(A), and a fabric body 16B in which the organic fiber cords 15 are arranged such that they intersect with each other are preferably used as shown in FIG. 3(B). The intersecting angle may be 90 degrees as shown in the drawing, or the cords 15 may be disposed in three directions and they may intersect with each other in a form of a triangle. In this embodiment, the fabric body 16B is used as the sheet-like body 16 of the wrapping member 17. Such a fabric body 16B has a small gap between the cords, and this is especially effective for preventing the permeation of rubber during vulcanizing.

It is preferable that the sheet-like body 16 is provided at its at least one surface, preferably both surfaces with topping rubbers 18 having small coating thickness. With this, the topping rubber 18 of the sheet-like body 16 can excellently be adhered to a carcass ply 6A. The sheet-like body 16 may not have the topping rubber 18, and the sheet-like body 16 may comprise only the cord arranging body 16A and/or the fabric body 16B.

In such a wrapping member 17, the organic fiber cord 15 can prevent the rubber from flowing during vulcanizing in a mold. Therefore, the rubber of the bead portion 4 is restrained from permeating into the bead core 5. Thus, the flexibility of the cable bead with respect to the twisting can be maintained, and the merit of the cable bead for enhancing the durability and steering stability can sufficiently be exhibited. Further, the wrapping member 17 can prevent the bead core 5 and the carcass ply 6A from coming into direct contact with each other. Thus, it is possible to prevent the carcass cord from being damaged. The sheet-like body 16 provided at its both surfaces with the topping rubbers 18 enhances the adhesion.

Since the wrapping member 17 has the organic fiber cord 15, the stability of shape, size, strength, and the like are secured. Thus, even if the thickness of the sheet-like body 16 is reduced, the operability of procedure for coating the bead core 5 with the sheet-like body 16 is not deteriorated by the extension, damage and the like. Further, the weight of the tire can be reduced. The thickness of the sheet-like body 16 is not especially limited, but it is preferable that the thickness is not more than 0.8 mm, and more preferably not more than 0.4 mm.

To prevent the rubber from permeating into the bead core 5 more reliably, the number of the organic fiber cords 15 per 5 cm of the sheet-like body 16 is preferably not less than 20, more preferably not less than 30, and also preferably not more than 40. When the sheet-like body 16 is the fabric body 16B, it is only necessary that the number of at least one of warps and wefts is in the above-described range. The upper limit of the number of threads is not limited especially. As the sheet-like body 16, it is possible to employ the cord arranging body 16A or the fabric body 16B in which a gap between the organic fiber cords 15 and 15 is substantially zero. Such a sheet-like body 16 can prevent the permeation of the rubber more excellently.

If the fineness of the organic fiber cord 15 is increased, the thickness of the wrapping member 17 is largely increased, and this is not preferable for weight reduction. In view of such a point of view, the fineness of the organic fiber cord 15 is preferably not more than 1500 dtex, more preferably not more than 1000 dtex, further preferably not more than 800 dtex, especially preferable not more than 400 dtex, and the organic fiber cord 15 is monofilament, twine or spinning thread. The lower limit of the fineness is not limited only if the stability of size, strength and the like of the wrapping member 17 can be secured.

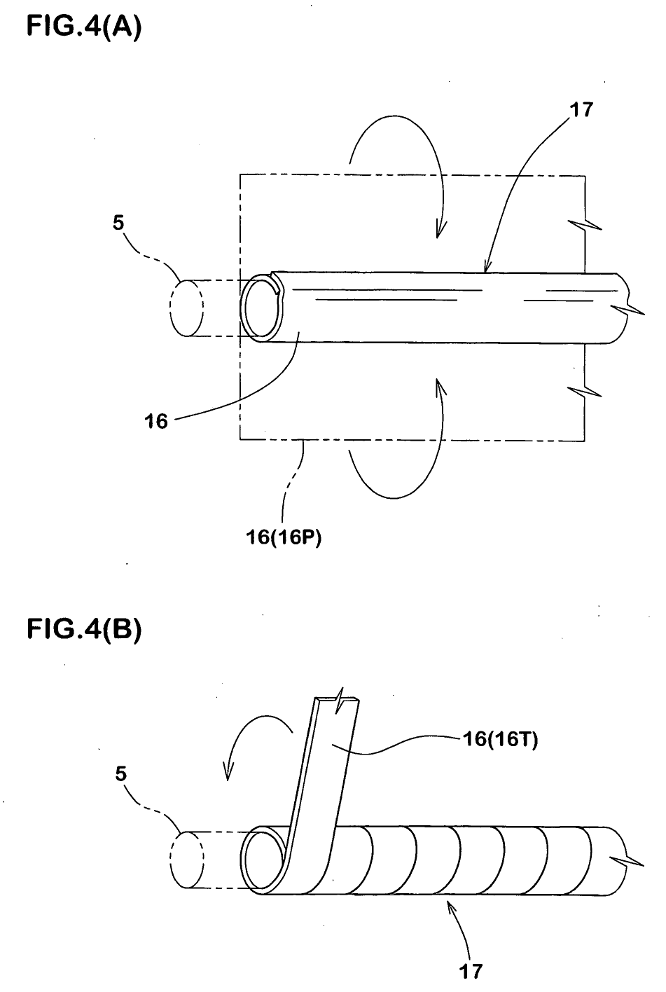

As the forming method of the wrapping member 17, the bead core 5 is wrapped by folding a wide fabric-like body 16P along the direction of a circumference of the bead core 5, and both edges of the body 16 are overlapped with each other so as to enclose the bead core 5 as shown in FIG. 4(A).

As shown in FIG. 4(B), the wrapping member 17 can also be formed by helically winding a narrow tape-like fabric-like body 16T around the bead core 5 as shown in FIG. 4(B). In this case, since the sheet-like body 16 and the bead core 5 are prone to adhere to each other, the finishing precision of the pneumatic tire 1 is enhanced. It is especially preferable that the tape-like sheet-like bodies 16T are wound such that their side lines come into contact with each other.

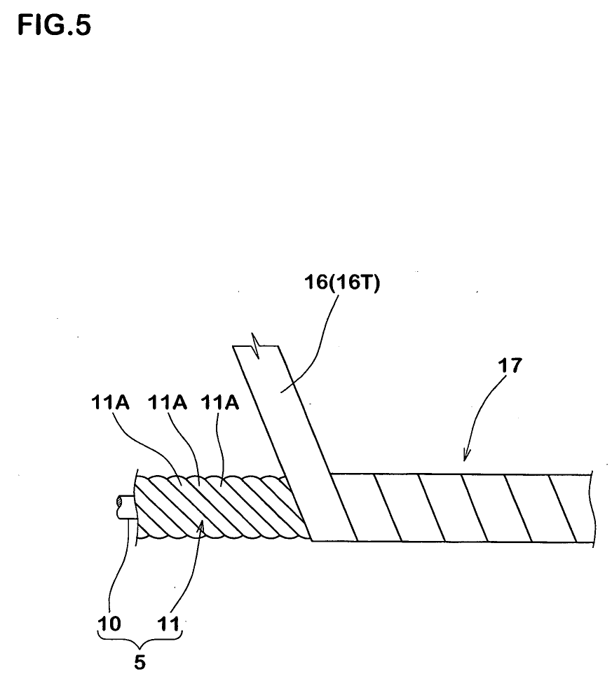

Further, if the helical direction of the fabric-like body 16 and the helical direction of the sheath wires 11A are aligned with each other as shown in FIG. 5, a force from the carcass ply 6A can directly be transmitted to the sheath wires 11A. Therefore, the distortion of the carcass ply 6A can be moderated more effectively.

Although the number of the sheath 11 is one in this embodiment, the number can be increased in accordance with required tire performance. In the sheath wire 11A, each sheath may have different material and diameter.

The tire of the present invention is not limited to a tire for a passenger car, and is employed for tires in various categories such as a heavy load tire, a small truck tire, an automatic two-wheeled vehicle tire, an aircraft tire and the like.

Although the especially preferable embodiment of the present invention has been described in detail, the invention is not limited to the illustrated embodiment, and the invention can variously be modified and carried out.

Comparison Test:

Radial tires (215/45R17) for a passenger car having the structure as shown in FIGS. 1 and 2 were manufactured based on the use shown in Table 1. Rim-assembling operability and the steering stability of these tires were tested in the following manner. For comparison, a rubber sheet having thickness of 1.0 mm was used instead of the wrapping member.

The common specification of the bead core is as follows:

Core

Diameter: 1.80 mm

Material: steel wire having carbon content of 0.5 wt %

Sheath

layer: 1

The number of sheath wires in cross section: 7

Diameter of sheath line: 1.40 mm

Material: steel wire having carbon content of 0.72 wt %

Rim-assembling Operability:

Each prototyped tire was manually mounted on a rim (17×7 JJ) using a tire lever, and the rim-assembling operability was evaluated on a scale from 1 to 10 while defining the conventional example as 6. The greater the numerical value is, the more excellent the rim-assembling operability is.

Steering Stability:

The prototyped tires were mounted on all wheels of a car (FR car of 2500 cc) under conditions of rim (17×7 JJ) and internal pressure (230 kPa), the car was allowed to run on a dry asphalt road surface which was a tire test course. Characteristics concerning a stick and a steering wheel response were evaluated by a driver's feeling evaluation on a scale from 1 to 10 while defining the conventional example as 6. The greater the numerical value is, the more excellent the steering stability is.

TABLE 1

| | Conven- | | | | |
|---|---|---|---|---|---|
| | tional | Ex. 1 | Ex. 2 | Ex. 3 | Ex. 4 |
| Wrapping | (Rubber | Presence | Presence | Presence | Presence |
| sheet | sheet) | | | | |
| Thickness | 1.0 | 0.75 | 0.4 | 0.75 | 0.75 |
| Cloth | — | arranging | Fabric | Fabric | Fabric |
| material | | body | body | body | body |
| Cord | — | Nylon | Vinylon | Nylon | Nylon |
| Fineness | | 1400dtex | 300dtex | 800dtex | 1000dtex |
| Arrangement | — | 49 | 44 | 49 | 49 |
| density (the | | | | | |
| number of | | | | | |
| cords/5 cm) | | | | | |
| Presence or | — | Both | Both | Both | Both |
| absence of | | surfaces | surfaces | surfaces | surfaces |
| topping | | | | | |
| rubber | | | | | |
| Rim- | 6 | 7 | 8 | 8 | 8 |
| assembling | | | | | |
| operability | | | | | |
| Steering | 6 | 7 | 8 | 7 | 8 |
| stability | | | | | |

In the case of the example tires of the present invention, flexibility of the bead core was secured and as a result, it could be confirmed that the rim-assembling operability and the steering stability were enhanced. In the case of the pneumatic tire of the invention, the adhesion between the bead core and a member which is adjacent to the bead core, e.g., the carcass ply or the bead apex can sufficiently be secured. Since the rubber is prevented from entering into the bead core by the lapping member, the flexibility of the cable bead structure is maintained, and its merit can sufficiently be exhibited. Since the lapping member has the organic fiber cord, the tire can be reduced in thickness and weight.

1. A pneumatic tire comprising:
a pair of bead portions;
a carcass comprising a carcass ply extending between the bead portions;
a pair of bead cores each disposed in each bead portion, said bead core comprising an annular core formed from one monofilament cord and a sheath having at least one sheath wire extending helically around the annular core; and
a wrapping member wrapping the bead core and made of fabric-like body having an organic fiber cord.

2. A pneumatic tire according to claim 1, wherein
said fabric-like body comprises organic cords each arranged with parallel.

3. A pneumatic tire according to claim 1, wherein
said fabric-like body comprises organic cords arranged at the direction which the cords intersect.

4. A pneumatic tire according to claim 1, wherein
said fabric-like body further comprises topping rubber coating at least one surface thereof.

5. A pneumatic tire according to claim 1, wherein
said carcass ply is turned up around the bead core wrapped by the wrapping member.

6. A pneumatic tire according to claim 1, wherein
said annular core has a diameter of from 1.5 to 8.0 mm.

7. A pneumatic tire according to claim 1, wherein
said annular core is made of a resin material having tensile elastic modulus of 1000 kg/mm² or less.

8. A pneumatic tire according to claim 1, wherein
said annular core is made of a metal material having carbon content of 0.1 to 0.9 wt %.

9. A pneumatic tire according to claim 1, wherein
said sheath wire is made of a hard-drawn wire having a diameter of from 0.8 to 2.6 mm.

10. A pneumatic tire according to claim 9, wherein
said sheath wire has a carbon content of in a range of from 0.65 to 0.88 wt %.

11. A pneumatic tire according to claim 1, wherein
said organic fiber cord has the fineness of not more than 1500 dtex.

12. A pneumatic tire according to claim 1, wherein
said organic fiber cord has the fineness of not more than 800 dtex.

13. A pneumatic tire according to claim 1, wherein
said organic fiber cord has the fineness of not more than 400 dtex.

14. A pneumatic tire according to claim 1, wherein
said wrapping member is formed by folding the fabric-like body along the direction of a circumference of the bead core, and overlapping both edges thereof.

15. A pneumatic tire according to claim 1, wherein
said wrapping member is formed by helically winding the fabric-like body around the bead core.

16. A pneumatic tire according to claim 15, wherein
said fabric-like body is helically wound with the same direction of the sheath wire.
